(19) United States
(12) Patent Application Publication
(10) Pub. No.: US 2007/0115934 A1
(43) Pub. Date: May 24, 2007

(54) Method and system for locating subscriber data in an IP multimedia subsystem

(75) Inventors: Samar K. Dauster, Blue Ridge, TX (US); Chou-Ling Ting, Plano, TX (US); Jeff Lin, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/285,758

(22) Filed: Nov. 22, 2005

(51) Int. Cl. H04L 12/66

(52) U.S. Cl. 370/352; 370/392

(57) ABSTRACT

A method for locating subscriber data in an IP multimedia subsystem is provided. The method includes receiving a subscriber location request for a user agent. The subscriber location request comprises a subscriber identifier that is operable to identify the user agent using one of at least two formats. One of a plurality of Home Subscriber Servers is identified as associated with the user agent based on the subscriber location request.

### TECHNICAL FIELD OF THE INVENTION

The present disclosure relates generally to IP multimedia subsystems and, more specifically, to a method and system for locating subscriber data in an IP multimedia subsystem.

### BACKGROUND OF THE INVENTION

Network-controlled multimedia services, such as voice, data, video and the like, may be provided by IP multimedia subsystems used in a single packet-switched network. These IP multimedia subsystems often include multiple Home Subscriber Servers. Each user agent in the IP multimedia subsystem has associated subscriber data stored in one of the Home Subscriber Servers. In attempting to locate this data, components of the IP multimedia subsystem may provide a subscriber identifier for the user agent in one of several different formats. However, conventional IP multimedia subsystems provide for locating this subscriber data based on one specified format. Therefore, there is a need in the art for a method of locating subscriber data based on subscriber identifiers in formats other than the specified format.

### SUMMARY OF THE INVENTION

A method for locating subscriber data in an IP multimedia subsystem is provided. According to an advantageous embodiment of the present disclosure, the method includes receiving a subscriber location request for a user agent. The subscriber location request comprises a subscriber identifier that is operable to identify the user agent using one of at least two formats. One of a plurality of Home Subscriber Servers is identified as associated with the user agent based on the subscriber location request.

According to another embodiment of the present disclosure, a system for locating subscriber data in an IP multimedia subsystem is provided. According to an advantageous embodiment of the present disclosure, the system includes an identifier translator and a subscriber location server. The identifier translator is operable to translate a plurality of subscriber identifiers from a second format to a first format. Each subscriber identifier is operable to identify a corresponding user agent. The subscriber location server is operable to identify one of a plurality of Home Subscriber Servers as associated with a specified user agent based on the corresponding subscriber identifier when the corresponding subscriber identifier is operable to identify the user agent using the first format.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary IP multimedia subsystem that is capable of locating subscriber data according to an embodiment of the present disclosure;

FIG. 2 illustrates a portion of the IMS core network of FIG. 1 in greater detail according to an embodiment of the present disclosure;

FIG. 3 is a flow diagram illustrating a subscriber locating operation using the IMS core network of FIG. 2 according to an embodiment of the present disclosure; and

FIGS. 4A-D are flow diagrams illustrating portions of the subscriber locating operation of FIG. 3 in greater detail according to an embodiment of the present disclosure.

### DETAILED DESCRIPTION OF THE INVENTION

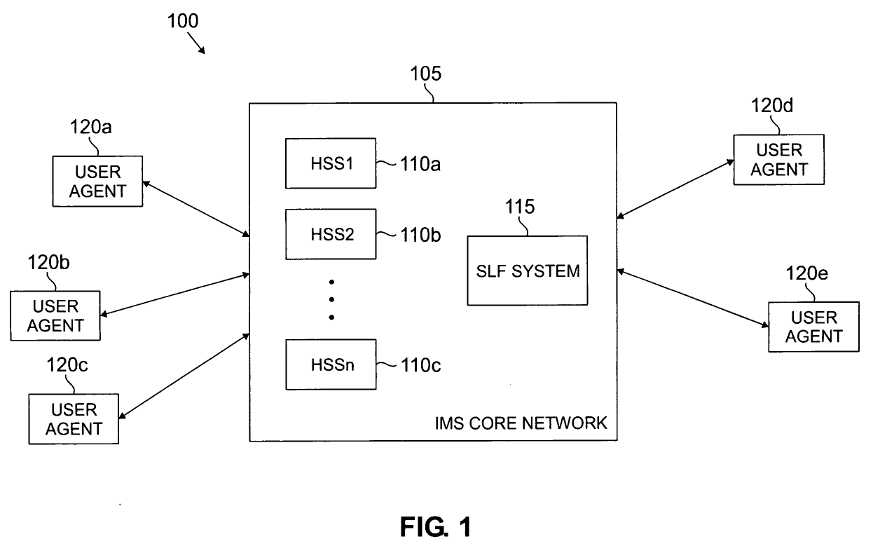

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged IP multimedia subsystem.

FIG. 1 illustrates selected portions of an exemplary IP multimedia subsystem 100 that is capable of locating subscriber data according to an embodiment of the present disclosure. IP multimedia subsystem 100 comprises IP multimedia subsystem (IMS) core network 105, which comprises a plurality of Home Subscriber Servers (HSSs) 110a-c and a Subscriber Location Function (SLF) system 115. It will be understood that IMS core network 105 comprises other suitable components not illustrated in FIG. 1.

IP multimedia subsystem 100 also comprises a plurality of user agents 120a-e. User agents 120 may each comprise a Session Initiation Protocol (SIP) phone, a Plain Old Telephone Service (POTS) phone, or any other suitable communication device. Although the illustrated embodiment comprises five user agents 120a-e, it will be understood that IP multimedia subsystem 100 may comprise any suitable number of user agents 120 without departing from the scope of the present disclosure.

IP multimedia subsystem 100 may be used in a single packet-switched network to offer network-controlled multimedia services, such as voice, data, video and the like. IP multimedia subsystem 100 allows users of user agents 120 to execute network services when roaming, as well as from their home networks.

IMS core network 105 comprises two or more HSSs 110. Each HSS 110 is operable to store subscriber data, such as user profiles and the like, for a portion of user agents 120 and to perform authentication and authorization for those user agents 120 based on the subscriber data.

SLF system 115 is operable to identify which HSS 110 corresponds to a particular user agent 120. Thus, when subscriber data is requested for a particular user agent 120, SLF system 115 may be queried to determine which HSS 110 is storing the requested subscriber data for that user agent 120. As described in more detail below, SLF system 115 is operable to identify an HSS 110 for a user agent 120 based on at least two different formats of subscriber identifiers. SLF system 115 is also operable to manage the logical aspects of the subscriber location data while hiding the physical location of the subscriber data from requesting applications.

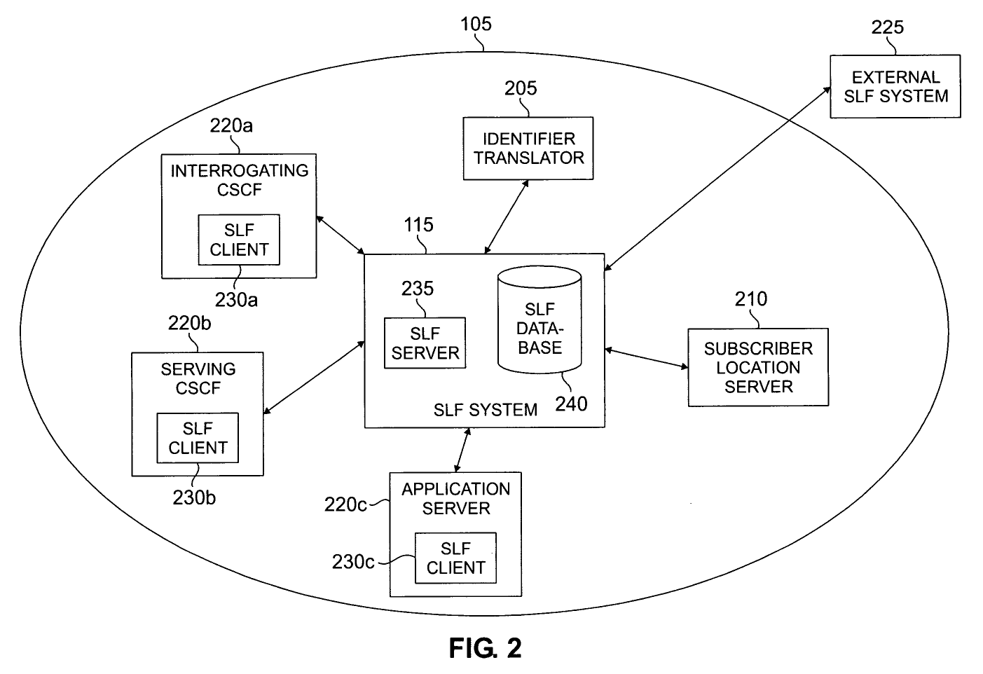

FIG. 2 illustrates selected portions of IMS core network 105 in greater detail according to an embodiment of the present disclosure. For the illustrated embodiment, IMS core network 105 comprises SLF system 115, identifier translator 205, subscriber location server 210, and a plurality of subscriber locating applications 220a-c. In addition, IMS core network 105 is operable to communicate with an external SLF system 225. However, as described in more detail below, for an alternative embodiment, IMS core network 105 may not comprise an internal identifier translator 205. For this embodiment, identifier translator 205 is implemented externally to IMS core network 105.

For one embodiment, SLF system 115 comprises SLF clients 230, an SLF server 235, and an SLF database 240. For the illustrated embodiment, each subscriber locating application 220 comprises a corresponding SLF client 230. Thus, although illustrated apart from SLF system 115, it will be understood that SLF clients 230 are part of SLF system 115.

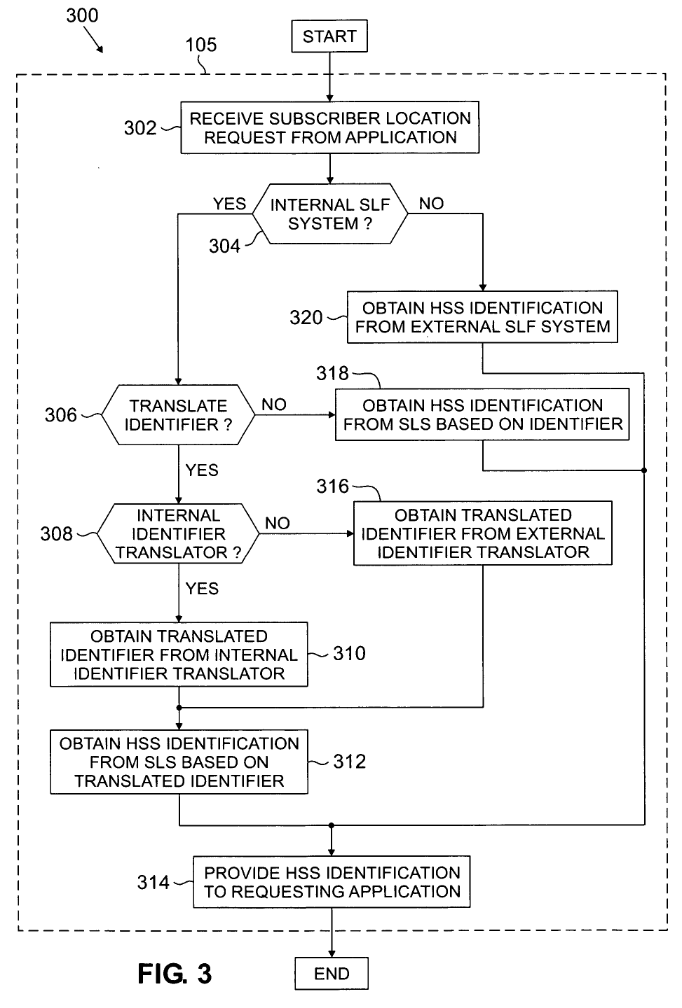

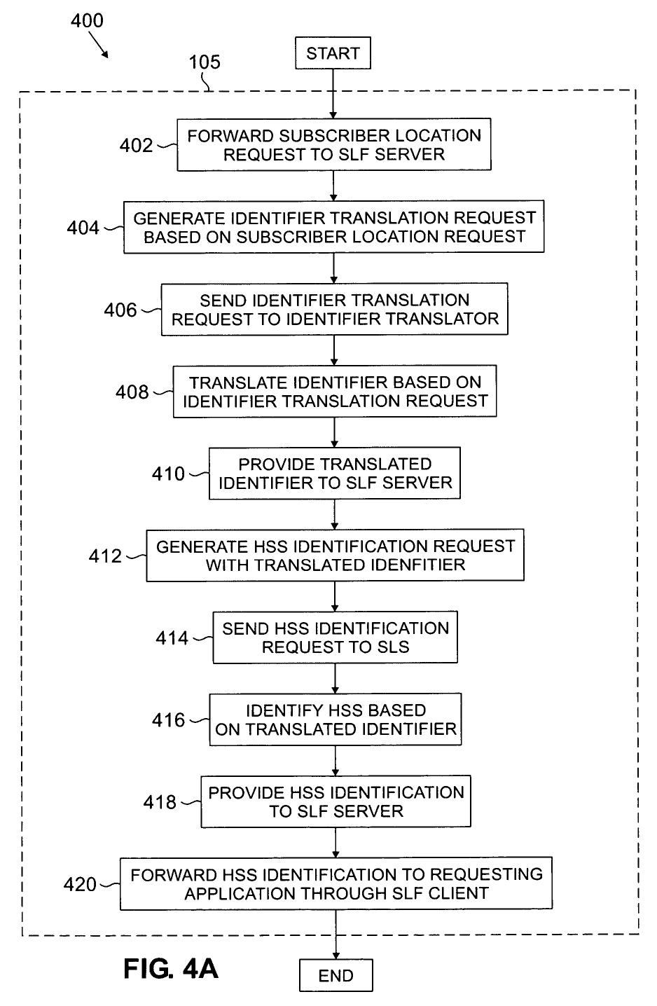

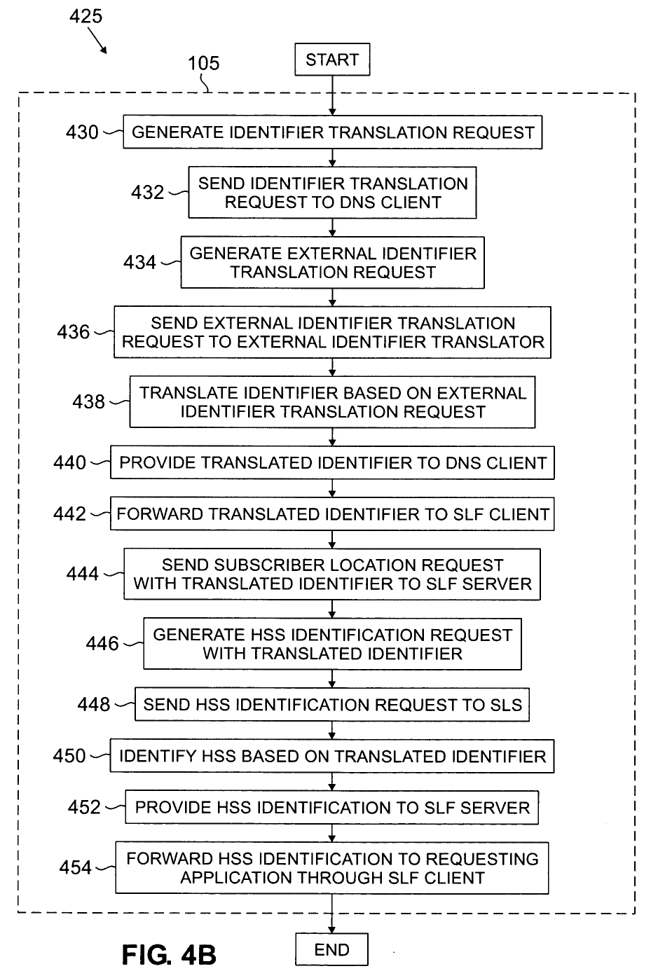

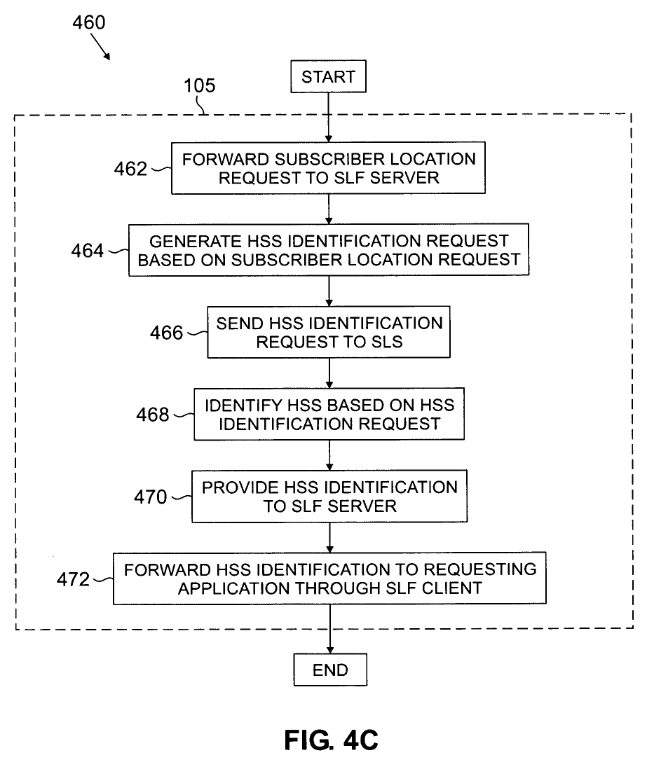

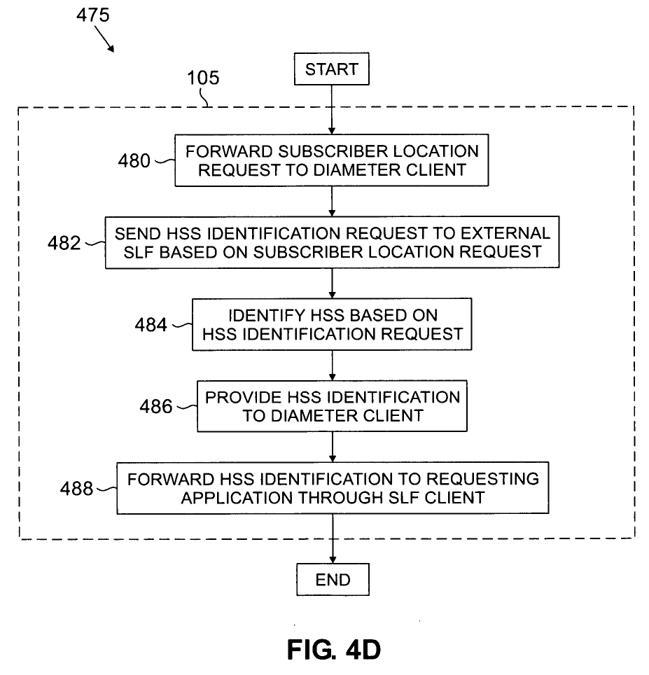

As described in more detail below in connection with FIGS. 3-4, each SLF client 230 is operable to forward a subscriber location request from its corresponding application 220 to SLF server 235. SLF server 235 is operable to receive a subscriber location request from an SLF client 230, to identify an HSS 110 based on the request, and to provide the HSS identification to the SLF client 230. In addition, SLF client 230 is operable to query SLF database 240 in order to determine whether identifier translator 205 is internal or external and to determine whether SLF server 235 is implemented in an internal SLF system 115 or an external SLF system 225. For one embodiment, SLF client 230 and SLF server 235 are operable to communicate with each other using Gen messages via Group Service.

Identifier translator 205 is operable to translate a subscriber identifier in a first format into a subscriber identifier in a second format. For example, for one embodiment, identifier translator 205 may comprise an E.164 Number Mapping (ENUM) server that is capable of translating telephone identifiers (i.e., common international telephone numbers) into SIP Uniform Resource Identifiers (URIs) for user agents 120. For this embodiment, identifier translator 205 may comprise a distributed Internet directory service.

Identifier translator 205 may be implemented locally as an internal identifier translator 205 for IMS core network 105 or remotely as an external identifier translator 205 for IMS core network 105. For the embodiment with an external identifier translator 205, SLF system 115 and the external identifier translator 205 are operable to communicate with each other through load sharing control.

Subscriber location server 210 is operable to identify an HSS 110 in which the subscriber data for a user agent 120 is stored based on a subscriber identifier for the user agent 120 that is in a specified format. For a particular embodiment, subscriber location server 210 is operable to identify the HSS 110 based on a subscriber identifier that comprises a SIP URI.

Subscriber locating applications 220a-c comprise components of IMS core network 105 that are operable to request subscriber location information for a user agent 105. Thus, for example, subscriber locating applications 220 may comprise an Interrogating-Call/Session Control Function (interrogating CSCF) 220a, a serving CSCF 220b, an application server 220c and/or other suitable applications capable of requesting subscriber location information.

Subscriber locating applications 220 each comprise an SLF client 230. SLF client 230 is operable to query SLF system 115 for an HSS identification whenever the corresponding application 220 desires or needs subscriber data for a user agent 120. For example, subscriber locating applications 220 may request an HSS identification, through SLF client 230, upon registration of a user agent 120, on session set-up, or the like. In a particular embodiment, interrogating CSCF 220a may request HSS identification on registration and mobile termination invite, and serving CSCF 220b may request HSS identification on registration.

Interrogating CSCF 220a comprises a contact point within an operator's network for all connections destined to a user agent 120 of that network operator or to a roaming user agent 120 currently located within that network operator's service area. For example, for one embodiment, interrogating CSCF 220a comprises a SIP proxy located at the edge of an administrative domain and for which an IP address is published in the Domain Name System (DNS) records of the domain so that remote servers can find interrogating CSCF 220a for use as an entry point to the domain for SIP packets.

Serving CSCF 220b is operable to perform session control services and also comprises a central node of the signalling plane that functions as a SIP server. Serving CSCF 220b is operable to handle SIP registrations for user agents 120, to inspect signalling messages, to identify an application server 220c to which a particular message is to be forwarded, to provide routing services and/or to perform any other suitable session control services.

Application server 220c is operable to host and execute services and to interface with the serving CSCF 220b using SIP. For a particular embodiment, application server 220c is operable to provide value-added IM services and may reside in a user's home network or in a third-party location. The third party may comprise a network, a stand-alone application server, or any other suitable third party. Although the illustrated embodiment shows a single application server 220c, it will be understood that IMS core network 105 may comprise any suitable number of application servers 220c. Application servers 220c may comprise a SIP application server, an Open Services Architecture (OSA) application server, a Customized Applications for Mobile Networks Enhanced Logic (CAMEL) IP multimedia service switching function (IM-SSF) application server and/or the like.

SLF system 115 is operable to identify which HSS 110 corresponds to a particular user agent 120 based on at least two different formats of user identifiers. For a particular embodiment, SLF system 115 is operable to identify the HSS 110 based on a subscriber identifier that comprises a SIP URI or a telephone number.

External SLF system 225 is operable to perform the functions performed by SLF system 115. However, external SLF system 225 is implemented externally to IMS core network 105 by a third party. Thus, for the embodiments in which an external SLF system 225 is implemented, each SLF client 230 is operable to send a subscriber location request to the external SLF system 225 for processing, to receive the HSS identification from external SLF system 225, and to provide the HSS identification to the corresponding application 220. For one embodiment, SLF clients 230 and external SLF system 225 are operable to communicate with each other through Load Share Client.

For one embodiment, if identifier translator 205 and subscriber location server 210 comprise relatively small databases, SLF server 235 may be implemented on each subscriber locating application 220 with an SLF client 230. However, if these databases are relatively large, SLF server 235 may be moved to other servers with more capacity. In addition, two or more SLF servers 235 may be implemented to handle additional capacity, with SLF queries being distributed in a round-robin or other suitable fashion. If identifier translator 205 and subscriber location server 210 comprise extremely large databases, the data may be distributed on different SLF servers 235. However, in this case, it may be desirable to use an external identifier translator 205 to alleviate the load of the SLF server 235.

FIG. 3 is a flow diagram illustrating a subscriber locating operation using IMS core network 105 according to an embodiment of the present disclosure. Initially, SLF client 230 receives a subscriber location request from its corresponding application 220 (process step 302). For a particular embodiment, the subscriber location request may comprise a processRequest (SLF_QUERY) message.

SLF client 230 then determines whether the SLF system 115 or 225 that will identify an HSS 110 based on the subscriber location request is internal or external (process step 304). For example, SLF client 230 may query SLF database 240 to make this determination. For a particular embodiment, SLF client 230 may send a locateSlf message to SLF database 240 and receive a return(Internal) message to indicate an internal SLF system 115 or a return(External) message to indicate an external SLF system 225.

If an internal SLF system 115 is to be used (process step 304), SLF client 230 determines whether the subscriber identifier for the user agent 120 received in the subscriber location request is to be translated or not (process step 306). For a particular embodiment, if the identifier comprises a telephone number, SLF client 230 determines that the identifier is to be translated into a SIP URI. On the other hand, if the identifier comprises a SIP URI, SLF client 230 determines that the identifier is not to be translated.

If the identifier is to be translated (process step 306), SLF client 230 then determines whether an internal or external identifier translator 205 is implemented (process step 308). For example, SLF client 230 may query SLF database 240 to make this determination. For a particular embodiment, SLF client 230 may send a locateEnumServer message to SLF database 240 and receive a return(Internal) message to indicate an internal identifier translator 205 or a return(External) message to indicate an external identifier translator 205.

If an internal identifier translator 205 is implemented (process step 308), SLF server 235 obtains a translated identifier from internal identifier translator 205 (process step 310). Thus, for the particular embodiment described above, SLF server 235 provides a telephone number to the internal identifier translator 205 and receives a SIP URI in return.

SLF server 235 then obtains an HSS identification for the HSS 110 corresponding to the user agent 120 associated with the subscriber location request from subscriber location server (SLS) 210 based on the translated identifier (process step 312). Thus, for the particular embodiment described above, SLF server 235 provides the SIP URI to subscriber location server 210 and receives an HSS identification in return. Finally, SLF server 235 provides the HSS identification to the requesting application 220 through its SLF client 230 (process step 314).

If an external identifier translator 205 is implemented (process step 308), SLF server 235 obtains a translated identifier from external identifier translator 205 (process step 316). Thus, for the particular embodiment described above, SLF server 235 provides a telephone number to the external identifier translator 205 and receives a SIP URI in return. As described above, SLF server 235 then obtains an HSS identification (process step 312) and provides the HSS identification to the requesting application 220 (process step 314).

If the identifier is not to be translated (process step 306), SLF server 235 obtains an HSS identification for the HSS 110 corresponding to the user agent 120 associated with the subscriber location request from subscriber location server 210 based on the identifier (process step 318). Thus, for the particular embodiment described above, SLF server 235 provides the SIP URI to subscriber location server 210 and receives an HSS identification in return. Finally, SLF server 235 provides the HSS identification to the requesting application 220 through its SLF client 230 (process step 314).

If an external SLF system 225 is to be used (process step 304), SLF client 230 obtains an HSS identification for the HSS 110 corresponding to the user agent 120 associated with the subscriber location request from the external SLF system 225 (process step 320). Thus, for the particular embodiment described above, SLF client 230 provides the identifier (which may be a telephone number or a SIP URI) to external SLF system 225 and receives an HSS identification in return. Finally, SLF client 230 provides the HSS identification to the requesting application 220 (process step 314).

FIGS. 4A-D are flow diagrams illustrating portions of the subscriber locating operation 300 in greater detail according to an embodiment of the present disclosure. FIG. 4A is a flow diagram 400 corresponding to steps 310, 312 and 314 of FIG. 3. FIG. 4B is a flow diagram 425 corresponding to steps 316, 312 and 314 of FIG. 3. FIG. 4C is a flow diagram 460 corresponding to steps 318 and 314 of FIG. 3. FIG. 4D is a flow diagram 475 corresponding to steps 320 and 314 of FIG. 3.

For FIG. 4A, SLF client 230 has determined that an internal SLF system 115 is to be used, the subscriber identifier is to be translated, and identifier translator 205 is internal to IMS core network 105. In this case, SLF client 230 forwards the subscriber location request to SLF server 235 (process step 402). For a particular embodiment, the subscriber location request forwarded by SLF client 230 may comprise a SLF_QUERY(Tel URI) message.

Based on the subscriber location request, SLF server 235 generates an identifier translation request (process step 404) and sends the identifier translation request to identifier translator 205 (process step 406). For a particular embodiment, the identifier translation request may comprise a getSipUri(Tel URI) message.

In response to receiving the identifier translation request, identifier translator 205 translates the subscriber identifier from a first format to a second format (process step 408) and provides the translated identifier back to SLF server 235 (process step 410). For a particular embodiment, the first format comprises a telephone number, the second format comprises a SIP URI, and identifier translator 205 provides the translated identifier back to SLF server 235 in a return(SIP URI) message.

SLF server 235 then generates an HSS identification request using the translated identifier (process step 412) and sends the HSS identification request to subscriber location server 210 (process step 414). For a particular embodiment, the HSS identification request may comprise a getHssName(SIP URI) message.

In response to receiving the HSS identification request, subscriber location server 210 identifies the HSS 110 in which the subscriber data is stored for the user agent 120 identified by the translated identifier (process step 416). Subscriber location server 210 then provides the HSS identification to SLF server 235 (process step 418), which forwards the HSS identification to the requesting application 220 through its corresponding SLF client 230 (process step 420). For a particular embodiment, the subscriber location server 210 provides the HSS identification to SLF server 235 in a return(HSS Name) message, SLF server 235 provides the HSS identification to SLF client 230 in a SLF_RESP(HSS Name) message, and SLF client 230 provides the HSS identification to the requesting application 220 in a return(HSS Name) message.

For FIG. 4B, SLF client 230 has determined that an internal SLF system 115 is to be used, the subscriber identifier is to be translated, and identifier translator 205 is external to IMS core network 105. In this case, based on the subscriber location request, SLF client 230 generates an identifier translation request (process step 430) and sends the identifier translation request to a DNS client (process step 432). For a particular embodiment, the identifier translation request may comprise a sendEnumQuery(Tel URI) message.

The DNS client generates an external identifier translation request based on the identifier translation request (process step 434) and sends the external identifier translation request to the external identifier translator 205 (process step 436). For a particular embodiment, the external identifier translation request comprises an ENUM QUERY(Tel URI) message.

In response to receiving the external identifier translation request, the external identifier translator 205 translates the subscriber identifier from a first format to a second format (process step 438) and provides the translated identifier back to the DNS client (process step 440). For a particular embodiment, the first format comprises a telephone number, the second format comprises a SIP URI, and the external identifier translator 205 provides the translated identifier back to the DNS client in an ENUM RESP(SIP URI) message. The DNS client then forwards the translated identifier to SLF client 230 (process step 442). For a particular embodiment, the DNS client forwards the translated identifier to SLF client 230 in a receiveEnumResp(SIP URI) message.

SLF client 230 sends the subscriber location request with the translated identifier to SLF server 235 (process step 444). For a particular embodiment, the subscriber location request comprises an SLF_QUERY(SIP URI) message. SLF server 235 then generates an HSS identification request using the translated identifier (process step 446) and sends the HSS identification request to subscriber location server 210 (process step 448). For a particular embodiment, the HSS identification request may comprise a getHssName(SIP URI) message.

In response to receiving the HSS identification request, subscriber location server 210 identifies the HSS 110 in which the subscriber data is stored for the user agent 120 identified by the translated identifier (process step 450). Subscriber location server 210 then provides the HSS identification to SLF server 235 (process step 452), which forwards the HSS identification to the requesting application 220 through its corresponding SLF client 230 (process step 454). For a particular embodiment, the subscriber location server 210 provides the HSS identification to SLF server 235 in a return(HSS Name) message, SLF server 235 provides the HSS identification to SLF client 230 in a SLF_RESP(HSS Name) message, and SLF client 230 provides the HSS identification to the requesting application 220 in a return(HSS Name) message.

For FIG. 4C, SLF client 230 has determined that an internal SLF system 115 is to be used and the subscriber identifier is not to be translated. In this case, SLF client 230 forwards the subscriber location request to SLF server 235 (process step 462). For a particular embodiment, the subscriber location request comprises a SLF_QUERY(SIP URI) message. In response to receiving the subscriber location request, SLF server 235 generates an HSS identification request using the subscriber identifier (process step 464) and sends the HSS identification request to subscriber location server 210 (process step 466). For a particular embodiment, the HSS identification request may comprise a getHssName(SIP URI) message.

In response to receiving the HSS identification request, subscriber location server 210 identifies the HSS 110 in which the subscriber data is stored for the user agent 120 identified by the identifier (process step 468). Subscriber location server 210 then provides the HSS identification to SLF server 235 (process step 470), which forwards the HSS identification to the requesting application 220 through its corresponding SLF client 230 (process step 472). For a particular embodiment, subscriber location server 210 provides the HSS identification to SLF server 235 in a return(HSS Name) message, SLF server 235 provides the HSS identification to SLF client 230 in a SLF_RESP(HSS Name) message, and SLF client 230 provides the HSS identification to the requesting application 220 in a return(HSS Name) message.

For FIG. 4D, SLF client 230 has determined that an external SLF system 225 is to be used. In this case, SLF client 230 forwards the subscriber location request to a Diameter client (process step 480). For a particular embodiment, the subscriber location request comprises a sendSlfQuery(SLF_QUERY) message. In response to receiving the subscriber location request, the Diameter client sends an HSS identification request to external SLF system 225 (process step 482). For a particular embodiment, the HSS identification request may comprise a DX_SLF_QUERY message.

In response to receiving the HSS identification request, external SLF system 225 identifies the HSS 110 in which the subscriber data is stored for the user agent 120 identified by the identifier (process step 484). External SLF system 225 then provides the HSS identification to the Diameter client (process step 486), which forwards the HSS identification to the requesting application 220 through its corresponding SLF client 230 (process step 488). For a particular embodiment, external SLF system 225 provides the HSS identification to the Diameter client in a DX_SLF_RESP message, the Diameter client provides the HSS identification to SLF client 230 in a receiveSlfResp(SLF_RESP) message, and SLF client 230 provides the HSS identification to the requesting application 220 in a return(HSS Name) message.

While several embodiments have been provided in the present disclosure, it should be understood that the disclosed systems and methods may be embodied in many other specific forms without departing from the spirit or scope of the present disclosure. The exemplary embodiments disclosed are to be considered as illustrative and not restrictive, and the intention is not to be limited to the details given herein. It is intended that the disclosure encompass all alternate forms within the scope of the appended claims along with their full scope of equivalents.

What is claimed is:

1. A method for locating subscriber data in an IP multimedia subsystem, comprising:
receiving a subscriber location request for a user agent, the subscriber location request comprising a subscriber identifier operable to identify the user agent using one of at least two formats; and
identifying one of a plurality of Home Subscriber Servers as associated with the user agent based on the subscriber location request.

2. The method as set forth in claim 1, further comprising:
determining whether an external subscriber location function (SLF) system is to be used; and
identifying one of the Home Subscriber Servers as associated with the user agent using the external SLF system when the determination is made that an external SLF system is to be used.

3. The method as set forth in claim 1, the at least two formats comprising a first format and a second format, identifying one of the Home Subscriber Servers as associated with the user agent comprising identifying one of the Home Subscriber Servers as associated with the user agent based on the subscriber identifier when the subscriber identifier is operable to identify the user agent using the first format.

4. The method as set forth in claim 3, further comprising translating the subscriber identifier from the second format to the first format when the subscriber identifier is operable to identify the user agent using the second format.

5. The method as set forth in claim 4, identifying one of the Home Subscriber Servers as associated with the user agent comprising identifying one of the Home Subscriber Servers as associated with the user agent based on the translated subscriber identifier that is operable to identify the user agent using the first format.

6. The method as set forth in claim 3, the first format comprising a Session Initiation Protocol (SIP) Universal Resource Identifier (URI) and the second format comprising an international telephone number.

7. The method as set forth in claim 1, receiving the subscriber location request comprising receiving the subscriber location request from an application, the method further comprising providing an identification of the Home Subscriber Server associated with the user agent to the application.

8. A method for locating subscriber data in an IP multimedia subsystem, comprising:
receiving a subscriber location request for a user agent, the subscriber location request comprising a subscriber identifier operable to identify the user agent using a first format or a second format;
translating the subscriber identifier from the second format to the first format when the subscriber identifier is operable to identify the user agent using the second format; and
identifying one of a plurality of Home Subscriber Servers as associated with the user agent based on the subscriber identifier that is operable to identify the user agent using the first format.

9. The method as set forth in claim 8, receiving the subscriber location request comprising receiving the subscriber location request from an application, the method further comprising providing an identification of the Home Subscriber Server associated with the user agent to the application.

10. The method as set forth in claim 8, further comprising determining whether the subscriber identifier is operable to identify the user agent using the first format or the second format.

11. The method as set forth in claim 10, further comprising requesting an identifier translation when the determination is made that the subscriber identifier is operable to identify the user agent using the second format.

12. The method as set forth in claim 11, translating the subscriber identifier from the second format to the first format comprising translating the subscriber identifier from the second format to the first format based on the identifier translation request.

13. The method as set forth in claim 8, the first format comprising a SIP URI format and the second format comprising an international telephone number format.

14. A system for locating subscriber data in an IP multimedia subsystem, comprising:
an identifier translator operable to translate a plurality of subscriber identifiers from a second format to a first format, each subscriber identifier operable to identify a corresponding user agent; and
a subscriber location server operable to identify one of a plurality of Home Subscriber Servers as associated with a specified user agent based on the corresponding subscriber identifier when the corresponding subscriber identifier is operable to identify the user agent using the first format.

15. The system as set forth in claim 14, further comprising an SLF server operable to receive a subscriber location request for the specified user agent, the subscriber location request comprising the corresponding subscriber identifier.

16. The system as set forth in claim 15, further comprising an SLF client operable to send the subscriber location request from a corresponding application to the SLF server and to provide an identification of the Home Subscriber Server associated with the user agent received from the SLF server to the application.

17. The system as set forth in claim 15, the SLF server further operable to determine whether the subscriber identifier is operable to identify the specified user agent using the first format or the second format.

18. The system as set forth in claim 17, the SLF server further operable to send an identifier translation request to the identifier translator when the SLF server determines that the subscriber identifier is operable to identify the specified user agent using the second format.

19. The system as set forth in claim 14, the first format comprising a SIP URI format and the second format comprising an international telephone number format.

20. The system as set forth in claim 14, the identifier translator comprising an E.164 Number Mapping server.
